(19) United States
(12) Patent Application Publication
(10) Pub. No.: US 2003/0164855 A1
(43) Pub. Date: Sep. 4, 2003

(54) Content management system

(76) Inventors: Stephen Grant, Ballynerrin (IE); Michael Coxeter, Mirabeau (FR)

Correspondence Address: Porter, Wright, Morris & Arthur LLP, ATTN: Intellectual Property Department, 28th Floor, 41 South High Street, Columbus, OH, 43215-6194, US

(21) Appl. No.: 10/376,213

(22) Filed: Feb. 27, 2003

(30) Foreign Application Priority Data
Mar. 1, 2002 (IE) S2002/0159

(51) Int. Cl. G09G 5/00

(52) U.S. Cl. 345/763

(57) ABSTRACT

A content management system for providing content that is specific to the execution context of a user application is disclosed. The invention relates specifically to applications that have a display in a browser that generates a document object model. The system comprises a development tool that is operative to record a specific execution context of the user application. The development tool makes a record that includes at least part of a document object model constructed by the browser and to associates content with the record. The system also comprises a content display tool that is operative to compare the execution context of the executing user application with records made by the development tool and to display content associated record having a corresponding execution context.

### BACKGROUND TO THE INVENTION

1. Field of the Invention

The present invention relates to a content management system. In particular, the invention provides a system that allows content to be associated with applications with reference to the context of the application's execution.

2. Summary of the Prior Art

Referring now to FIG. 1, the Assistware version 3.0 suite of applications from Baydon Solutions, Dublin, Ireland (see http://www.baydon-solutions.com/mainBody.htm) allows content 22 to be associated with platform-specific target applications 12.

The suite includes a camera application 14 that runs on a content developer's computer 10 in conjunction with the target application with which the content is to be associated. The developer runs the target application 12 and, through user interaction or otherwise, moves from context to context within the application, each context comprising one or more displayed windows. At each context with which content is to be associated, the camera application is used to capture data that identifies the context. (The term developer is used throughout the present specification to mean a party producing a content management system; it does not necessarily mean that persons producing such systems need to have advanced programming ability.)

In the case of Microsoft Windows operating system based applications, it will be appreciated that each displayed window in fact comprises a hierarchy of parent and child windows, and that objects such as buttons, dialog boxes, text etc. are also constituted by one or more windows. When the camera application 14 is launched or subsequently activated, the mouse pointer changes state to become a pointer for the camera application—the pointer changing to a camera-like icon indicates this. As the pointer passes over portions of a displayed target application window, the camera application uses operating system window handle information to highlight the window within the displayed window hierarchy over which the pointer is located. If the developer clicks a mouse button, the camera “takes a photograph” of the highlighted window. This taking of a photograph comprises making an operating system call to retrieve the details of the highlighted window including a screen capture and saving these details—shown here as context storage 18.

A photograph album 16 comprises a second application in the suite and this enables a developer to examine the saved details associated with screen captures and to specify distinguishing criteria for these details by which the window in the captured context can be identified. These distinguishing criteria become part of the stored context from the target application with which the developer wishes to associate content. During this process, the application can execute either on the developer's local computer or from a remote server

At the same time, content to be associated with the context is produced by, for example, an authoring package 20. This does not need to run on the developer computer. The content 10 comprises, for example, a database of HTML (Hyper-Text Mark-Up Language) documents which when selected and retrieved can be rendered within a browser session 40. The documents can also be inter-linked to allow users to navigate through the content from an initially selected document associated with a given target application context. The photograph album 16 operates in conjunction with the content database, to allow the developer to specify content to be associated with a context, this context typically being a given window where the selected criteria are met. The content database 10 along with the matching criteria stored as context 18 are packed in an index file 22 accessible from computers 30 where end users run their instances 12′ of the target application.

In order to access content associated with the target application, the end user employs a bubble application 26 installed on their computer 30. FIG. 2 shows a sample screen shot where a screen 28 for the target application 14 is running. The screen shot further shows an icon 32 for the bubble application. The bubble application 26 includes common functionality with the camera application 14 in that, when launched by clicking the icon 32, it changes the displayed state of the mouse pointer to a bubble-like icon 34. The bubble application further highlights the windows of the target application over which the pointer is located in the same manner as the camera when employed by the developer. In FIG. 2, a window 36 showing order details for a customer has been highlighted.

When the user clicks a mouse button, the details of the window are retrieved by the bubble application, again using an operating system call. The bubble application uses these details and compares them with details in the index file 24 to determine if there is any matching content in the index file. If the application 38 finds a match, the associated content is retrieved and transmitted to the end-user computer 30 where the bubble application 26 causes the content to be rendered. In this case, a browser 40 renders the content in a dedicated window 42, FIG. 2. As mentioned above, this content can act as a start point from which the user can link to other related content. The system described may, as an example, be used to provide a user with context-sensitive help for operating the application.

Recently, however, more and more applications are being deployed through the Internet rather than as standalone applications. While the system describes above operates quite satisfactorily with a browser in so far as it is a platform specific target application, it is the content displayed by a browser which is of interest to the developer who wishes to provide an end user with context-specific content.

It is acknowledged that many users operate a browser with an address toolbar displaying the URL corresponding to the content displayed in the browser's content window. To some extent, the URL therefore provides a limited indication of the context of a web application. With some adaptation, the camera application could even be adapted to look for URL-type text within an address toolbar associated with a window which had just been photographed.

However, more and more web applications now generate web pages dynamically using for example, JavaScript, Dynamic HTML, Microsoft Active Server Pages (ASP) or Java Server Pages (JSP) from Sun Corporation. While these ultimately produce at least to some extent HTML, the URL may be extremely complex including, for example, session identifiers, encrypted user identifiers, servlet commands etc. Clearly, to require someone other than the programmer of the web application to ascertain the meaning of such URLs would be extremely onerous.

### SUMMARY OF THE INVENTION

Therefore, it is an aim of this invention to provide a system by which content can be associated with a context in a web-based application to a similar level and with similar degree of ease as is the case with the system described above for conventional applications.

According to the present invention there is provided a content management system comprising: a development tool operative to record a specific execution context of a user application displayed in a browser by making a record including at least part of a document object model constructed by the browser and to associate context-specific content with the record; and a content display tool operative to compare the execution context of an executing user application that has a display on a browser with records made by the development tool and to display content associated record having a corresponding execution context.

While the invention employs a similar approach to the prior art of photographing a context, distinguishing the context, connecting content to the context, and accessing the content with the context display tool (the bubble), the major difference is that this is done with reference to the DOM that is present in a particular application context rather than by reference to the rendered display. This can provide a level of contextualization that cannot be achieved with reference to, for example, the URL alone.

In a content management system embodying the invention, the development tool may associate a representation of a display upon which the user application is visible at the execution context in the record. A content management system according to claim 2 in which the representation includes an encoded image representing the application display. That is to say, a screenshot may be included in the record. The screenshot is preferably encoded in an image file format, and more preferably a compressed format such as JPEG format.

The record may include the complete document object model in existence at the specific execution context. This allows a developer a great degree of freedom when choosing elements of the document object model that identify a context. The record may also includes additional information relating to the execution context of the application. This may be extracted from the document object model or it may be additional to it. For example, the information may include one or more selected from: the HTML title value of the page captured, the name of the domain from which the photograph was captured, the URL of the page captured, all the text in the captured page and all the HTML of the captured page. The record may include one or more distinguishing elements of the context by which the context may be identified. The distinguishing elements typically include one or more items in the document object model.

Most typically, the record includes a definition of an action to be associated with the context. In use, the action defined by the record can most be initiated by the content display tool. For example, the action defined by the record is initiated in response to an input by a user. The action may include displaying a page in a browser. Alternatively or additionally, the action may include executing an application.

In typical embodiments, the record includes XML code.

The development tool can be an application executing on a developer computer. Likewise, the content display tool can be an application executing on a user computer. Most usually, the content display tool and the user application will execute on the same computer.

From another aspect, this invention provides a content development system comprising a development application operative to record a specific execution context of a user application that has a display context displayed in a browser, the development application operating to make a record including at least part of the document object model of the browser, and to associating content with the execution context in the record.

From a third aspect, this invention provides a display system for displaying content with reference to the execution context of a user application that is executing with a display in a browser in which upon receipt of a request for content, the display system is operative to compare elements of a current document object model generated by the browser with records that define execution content with reference to the document object model, and upon location of a correspondence between the current document object model and a record to cause content to be displayed in accordance with a definition in the record.

From another aspect, the invention provides a method of providing content specific to the execution context of a user application that has a display in a browser, the method comprising a content development phase in which the user application is executed and at each of a plurality of contexts with which content is to be associated, a record is made of a document object model of the browser and a reference to a content item is associated with the record; and a content display stage in which the user application and a content display tool are executed and the content display tool, the display tool, upon receiving a user request for content, compares a current document object model of the browser displaying the user application with the records made in the development phase, and displays content associated with a record that corresponds to the current document object model. In this regard, correspondence between the recorded and current document object models may be determined as having occurred when features of the current and recorded models match one another in accordance with one or more rules contained in the record.

### BRIEF DESCRIPTION OF THE DRAWINGS

FIG. 1 is a schematic diagram illustrating the components and operation of the prior art Assistware suite of applications;

FIG. 2 is a screen shot of an end-user running the prior art Assistware bubble application;

FIG. 3 is a schematic diagram illustrating the components and operations of a preferred embodiment of content management system according to the present invention;

FIG. 4 is a screen shot of an end-user running a connector component of the content management system of FIG. 3;

FIG. 5 is an item distinguishing dialog box produced by the connector of the content management system of FIG. 3; and

FIG. 6 illustrates a toolbar which runs on an end-user computer accessing content according to the invention.

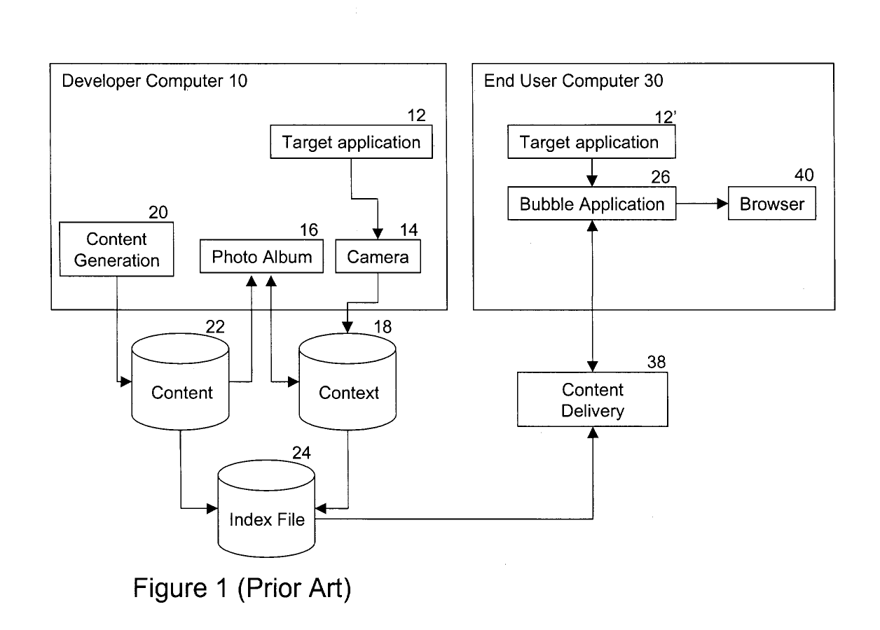

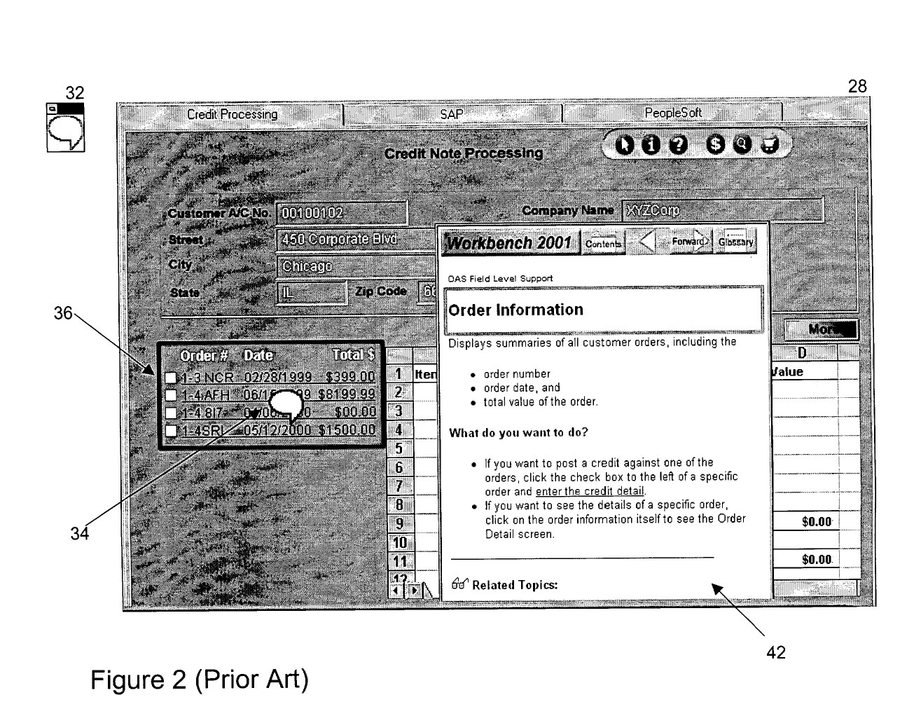

### DETAILED DESCRIPTION OF A PREFERRED EMBODIMENT

An embodiment of the invention will now be described with reference to the accompanying drawings.

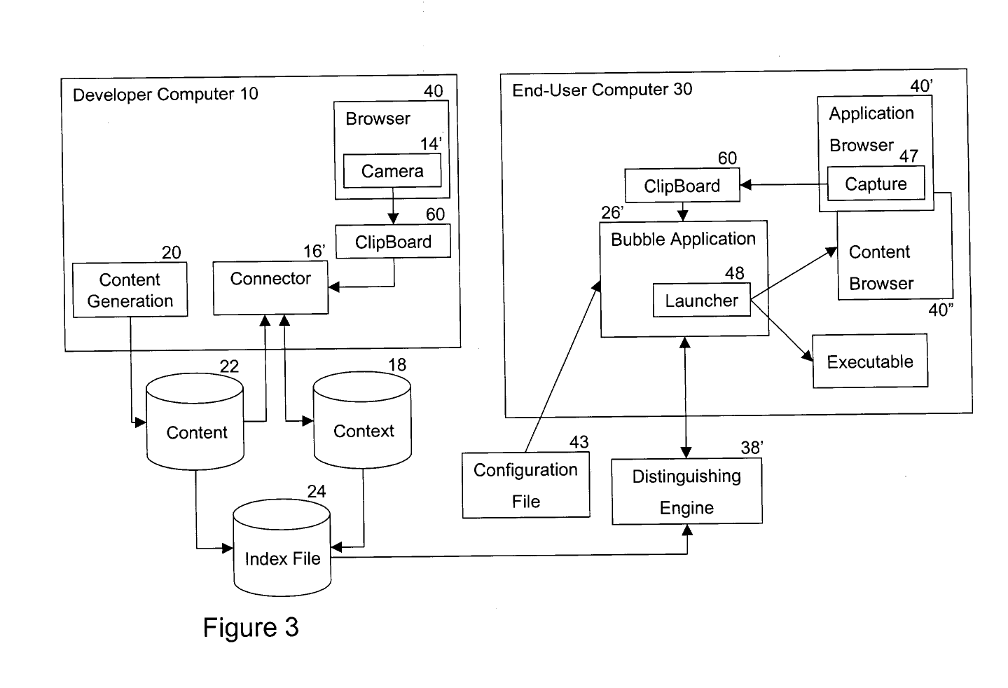

Referring now to FIG. 3, a preferred embodiment of content management system will be described in relation to a Microsoft Windows operating system and an Internet Explorer Version 5.5 or later browser.

When parsing a HTML document received in a Hyper Text Transfer Protocol (HTTP) response to a HTTP request, these versions of browser generate a document object model (DOM) which comprises a hierarchical object-based view of the HTML document to be rendered by the browser. As explained above, more and more web-based applications employ dynamically generated HTML so the HTML that is actually received in response to a HTTP request may comprise script functions etc. These functions which may result in further HTTP requests for HTML that will be included in the final document to be rendered or even in manipulation of the HTML already received. Thus, the final DOM resulting from an initial HTTP request may not have a one-to-one correspondence with the HTML received in the initial HTTP response. This is probably best exemplified by the small contrast between the small amount of source HTML defining a web frame page, and the final HTML eventually received and parsed to provide the DOM that is to be rendered by the browser. Nonetheless, it should be noted that the DOM hierarchy also includes a HTML node including the original HTML that produced the DOM.

The content management system embodying the invention comprises several components wrapped up in two main applications, the first of which is referred to as the Connector. The connector is installed on a developer computer 10 and includes components 16′, 14′ corresponding to the photograph album 16 and the camera application 14 respectively of the prior art. In the preferred embodiment, the connector has its own self-contained installation program, which can be downloaded and installed from the Internet or any other network. The installation routine installs all the required binary files and help-files for the editor 16′ and creates a new program group allowing the application 16′ to be launched. In the preferred embodiment, the camera 14′ comprises an “invisible” camera toolbar which is instantiated with every instance of the browser 40 running on the developer computer.

The second application is a modified bubble application 26′ that will be described in more detail later. Normally, this is also installed as part of the connector install, so that a developer, using the computer 10, can test the system. Again, installation of the bubble application 16′ is achieved by simply calling a separate installation program. Preferably, an uninstall option is provided for both the bubble and connector applications.

In general, the connector components 14′, 16′ allow a developer to: take photographs of web applications running within a browser 40; edit photograph albums and photographs and connect distinguished photographs (context 18) to external support material 22; and generate index files 24 which are referenced at runtime by a bubble application 26′ executed by an end-user running on an end-user computer 30′.

In the preferred embodiment of the invention, an album can include a hierarchy of photographs and folders and is stored as a file in a location on the computer 30, either according to the configuration of the connector 16′ or a location specified by the developer.

The root of an album contains photographs and folders (with the folders in turn containing other folders and photographs as required in an expandable hierarchy). Multiple levels of folders are provided for, because it is highly likely that developers will be working with many (for example, double-digit numbers) of photographs in any one album. Thus, folders allow developers to categorize their photographs and to subdivide an album for ease of reference.

Each photograph comprises an XML file that has a document type definition (DTD) or grammar requiring the following components:

an image comprising a picture of the web application screen at the time the photograph was taken,

the distinguishing details of the photo, and

content associated with the photo.

In the prior art, the distinguishing details are based on the operating system details of the window selected by the camera application 14. In the preferred embodiment, the distinguishing details include the DOM for the browser content. For ease of use, some of the more regularly distinguished elements of the DOM, i.e. Title (the HTML title value of the page captured), Domain (the name of the domain from which the photograph was captured), URL, innerText (all the text in the captured page) and HTML (all the HTML of the captured page) are duplicated within the photograph and are employed as high level primary distinguishing elements of the photograph. The remaining item is the entire DOM itself, this is effectively a hierarchical grouping by type of all the DOM items captured, or looking at it another way, a grouping by object type. The DOM itself is a primary distinguishing element of the photo, however, if a developer wishes to distinguish on some other element of the DOM, this may require some navigation through the DOM hierarchy to locate the element.

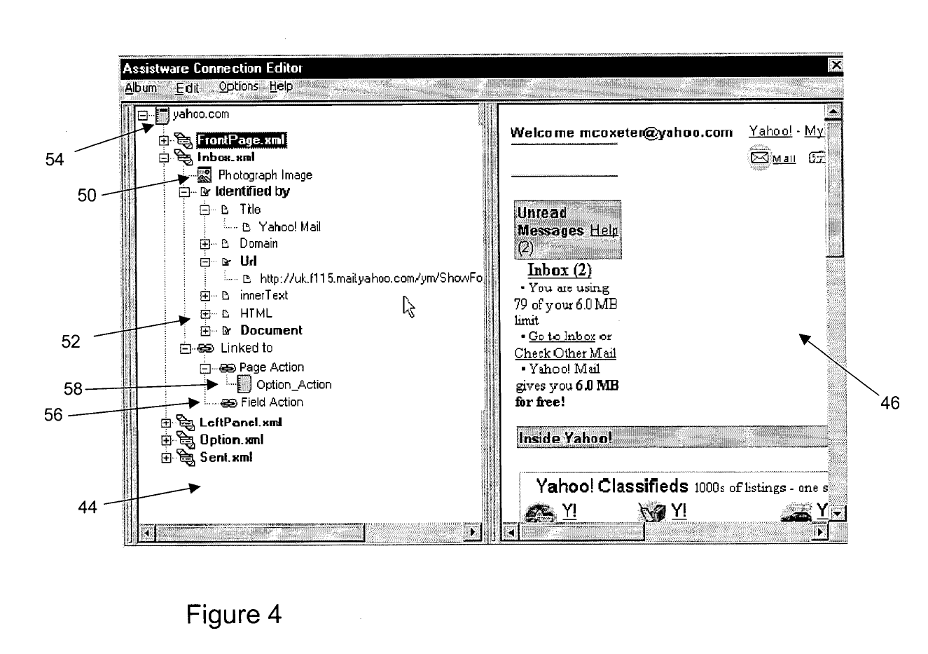

Referring now to FIG. 4, which shows a screen shot of the connector 16′. The connector is split into 2 views, an album explorer view 44 and photograph view 46. As explained above, an album comprises one or more photographs and the connector comprises a parser, which first reads an album file and, for each photograph referenced in the album file, parses the photograph XML file. The connector further comprises a renderer, which reads the respective DOMs produced by parsing each photograph XML file for an album and renders these in the hierarchical explorer type view 44, with which the user can interact. Examples of such interaction include:

Renaming a folder by right clicking on it and selecting a Rename menu option; or single left clicking inside the current title.

Creating a folder by clicking on either a blank area of an open album window 44 and selecting an “Insert New Folder” menu option, in which case a folder appears in the root of the album tree at the bottom with its title highlighted. This allows the user to enter a new title. Similarly the developer could select an “Edit -> New folder” option from a drop down menu. Otherwise the developer could right click on a photograph and select “New Folder” from a pop-up window, with the folder being inserted at the same hierarchy level as the selected object and placed directly below it, again with the default title highlighted.

Moving photographs between folders by conventional drag and drop techniques.

Move entire folders and their contents via a drag and drop action. Inter-album window moves could also be supported both at photograph and folder level and these would preferably trigger a confirmation dialog, such as “You are about to move objects from one album to another. Are you sure you wish to continue?” [Y] [N].

Standard single and multi-select by holding down the Shift key to select objects between the outer most selections, or holding down the Ctrl key to select individual objects.

Mixed selection is possible i.e. any combination of photographs and folders. In this case, the right hand side of the editor window 46 contains an image of the last singly selected photograph.

The photograph view area 46 is used to either render the HTML contained in the HTML node of a selected photograph or display an image of the screen at the time the photograph was taken (preferably in JPEG format) from the photograph node of the selected photograph. In the preferred embodiment, a browser COM object, which would be installed on a machine running Internet Explorer (IE), exposes an API (Application Programming Interface) enabling the connector to cause the browser object to render either HTML or JPEG provided within the photograph view area 46. Thus, if the user selects a picture icon 50 in the album view 44, the connector passes the image as a parameter in an API call on the browser COM object. At all other times the photograph view will attempt to render the HTML 52 of the captured photo. Again, the connector can do this by passing the HTML as a parameter in an API call on the browser COM object. As this HTML will be rendered in the normal fashion, errors may occur, for example, a graphic or applet may not display if the address is not resolvable or if the user is not already logged on to a secure or private web page, the application will attempt to ‘gag’ these errors.

To actually take photographs of a web application the developer launches the connector 16′ and opens either an existing or a new album. Once an album is open a Capture menu option is enabled. Selecting this triggers a camera function and a camera icon appears in the system tray (not shown). Preferably, it flashes on/off indicating the capture/camera mode is active. Using a browser session 40, the developer then navigates to the desired web application screen and ‘takes a photograph’. This is achieved by placing the cursor within the web application window to be captured and preferably holding down the Alt key and right clicking the mouse. This causes the invisible camera toolbar 14′ to retrieve the DOM for the window as well as a screen capture of the window and to copy this to the system clipboard 60.

When capture/camera mode is active, the connector 16′ becomes a listener for events indicating that the clipboard has been updated. When such an event is detected, the editor generates a photograph comprising an XML file including the screen shot image and the DOM. This file is given a default name based on the title of the frame/screen captured and stored in a location on the computer 30 according to the configuration of the connector 16′.

Once captured, a photograph appears in the open album, entering at the root level below the last entry in the album. It can then be moved and or renamed as required using conventional type explorer user-interaction as explained above.

In the example of FIG. 4, the root is an album 54 named “Yahoo.com”. In this case, the album contains only the photographs Frontpage.xml, Inbox.xml etc., and does not contain folders.

Expanding a photo, in this case, Inbox.xml, reveals: a ‘picture’ of the screen 46 at the time the photograph was taken; the root of the distinguishing details of the photograph—“Identified by”; and the root of the actions associated with the photograph—“Linked to”.

Expanding the “Identified by” section reveals the ‘primary’ distinguishing items of the photograph i.e. Title, Domain, URL, Inner Text, HTML. The remaining item called Document, is the entire DOM (Document Object Model) of the photograph and includes the primary distinguishing items as well as all other attributes in the DOM (of which there are many).

Expanding a distinguishing item reveals further detail about that item, it may be a ‘leaf node’, i.e. a bottom level of the tree, and is presented with the detail in the distinguish item OR the item may be another hierarchy.

When, for example, Title is expanded, it reveals the actual detail in that particular title (Yahoo Mail in the case of FIG. 4). Once an item has been distinguished (see later) the item is preferably displayed in blue. This also applies to the parent(s) of the item, thus indicating that an element in the hierarchy is distinguished. For example, if the developer distinguishes on Title, the photograph name turns blue, as the photograph is a parent of the title item—thus indicating that the photograph is distinguished (by one or more items).

In the preferred embodiment, the relationship between distinguished items for a photograph is an AND relationship, i.e. both criteria must be met in the relationship in order for the action to be triggered. For example, if a photograph is distinguished on Title and Domain, both distinguishing criteria must be met in order for the photograph to be ‘recognized’. It will be seen that additional Boolean logic may be added to these relationships.

Once distinguishing is complete, a support action can be ‘attached’ to the photograph i.e. the photograph can be associated with an action (see later) such that if the screen is recognized during an end-user support request, the action is then triggered. The “Linked to” item displays the action(s), if any, associated with photo. In the preferred embodiment, the action comprises an action script file which in turn comprises one or more different types of actions. To associate an action with the entire photograph the developer can either:

1. Drag an HTML page displayed in an instance of browser 40 and drop it on a non-highlighted area of the photograph in the photograph view area 46. This automatically creates an action script file for the photograph and adds a page launch action into the action script file.

2. Within an instance of browser 40, navigate to a URL, then drag the URL from the address toolbar and drop it on a non-highlighted area of the photograph in the photograph view area 46. This again automatically creates an action file for the photograph and adds the page launch action into the action script file.

If an action script file is already present, another script file is created and associated with this photograph and the launch page action is added to the second action file script. All action files associated with the screen level of the photograph appear in the “Linked to” section of the photograph under Page Action. These files can be renamed but the name must be unique, as they have associated physical XML files.

In the example shown, the connector 16′ only supports manipulation of a single album at a time. However, it is also possible to have multiple simultaneous copies of the editor running, each editing a different album.

As mentioned above, distinguishing a photograph from a web application comprises setting attributes by which a web application screen will be identified. At the screen or page level, a web photograph comprises a hierarchy of DOM (Document Object Model) items, with each DOM item being represented as a branch in the root of the photograph object. The items at the root level are those that are most likely to be useful when attempting to distinguish a particular photograph.

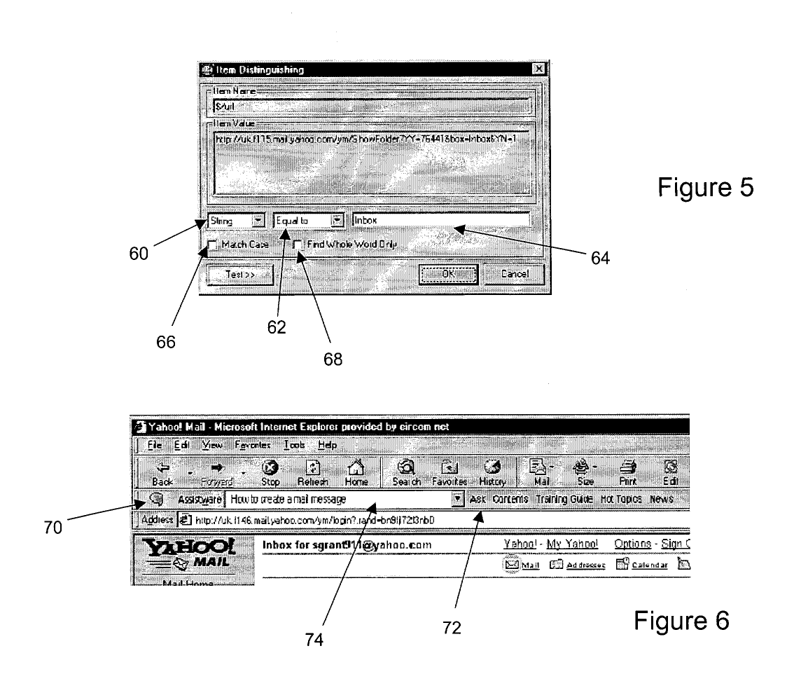

To use one or more of these items to identify a photograph, the developer double-clicks on the leaf of the item and this causes the connector to display an Item Distinguishing dialog, FIG. 5. The item distinguishing dialog allows the developer to specify the ‘matching constraints’ to use against this DOM item. The developer can specify the type of the data and value to look for to register a match. In addition the connector allows the developer to test their values via the “Test” button. In the example, of FIG. 5, the developer has selected the URL node of the photograph—or alternatively selected this node within the DOM node. In the case of the photograph being viewed, the web page URL is:

http://uk.f115.mail.yahoo.com/ym/ShowFolder?YY=76441&box=Inbox&YN=1

Clearly, unlike a corresponding screen in a more conventional application, this URL will vary greatly in use. In this case, it may vary according to the mail server a user may be employing and according to the session and their username etc. However, in terms of providing content related to this web page, the developer notes that one of the switches within the URL is “Inbox” and decides to provide content for URLs including this string Inbox. Clearly to avoid confusion with other sites including the string “Inbox” within their URL, the developer might also consider distinguishing on the Domain item. Nonetheless, the same techniques are involved for distinguishing on any item. Thus, in the entry fields 60, 62, 64 provided, the developer can specify, for example, that a string data type is to be matched, that the criterion to be met is, for example, equality and that the test string is “Inbox”. When string type matching is selected, two further check boxes 66 and 68 are displayed enabling the developer to specify if case is to be matched, or if the whole URL needs to match with the test string clearly not in the present example. Nonetheless, when these distinguishing criteria are specified, they are stored within the item node of the photograph XML file.

It is also possible to distinguish an area (or field) in a screen/page and associate a separate action with the field, in essence creating field level support. It will be seen, however, that before first being able to distinguish a field, it is first necessary to place the field within the context of a page. Thus, in the preferred embodiment, actions associated with fields are stored as child nodes 56 of “Linked to” within a photograph, FIG. 4.

To mark an area as a field area to be distinguished the developer:

1. Selects the photograph that contains the field and clicks on anywhere other than the Photograph Image 50 in the Album Explorer View area 44. This is because the Photograph View Area needs to be rendering the HTML for the photograph as opposed to displaying an image of the photo.

2. Then in the Photograph View area 46, the developer places the cursor in the area to be ‘field distinguished’ and then preferably holds the Alt key and right clicks the mouse. The connector can now interrogate the DOM produced by the browser COM object when rendering the HTML and can traverse the DOM hierarchy to determine which element of the DOM has been selected by the developer. The selected element is then used as a distinguished item of a sub-photograph, which the connector places in the “Linked to” section of a photograph as a Field Action item.

3. The connector attempts to name the field photograph based on the attributes in the DOM element. However, the developer can subsequently re-name it as appropriate (the name must be unique to the album) using the conventional type interaction techniques described above.

4. When the developer double-clicks on a field action item, an Item Distinguishing dialog appears as in FIG. 5 above. As before, the developer can specify the identification constraints for the field in question.

5. Associating an action with a field item is achieved as with photographs, for example, by dragging an HTML page and dropping it on the particular field sub-photograph under the Field Action section of the photograph. This again automatically creates an action script file with similar characteristics to that of a screen level action script file.

6. Once this is done, the connector responds to the selection of a field item by highlighting within the photograph view area 46 the area(s) in the photograph that match the constraints specified. So, for example, if the field item were a hyperlink called OK, and using the Item Distinguishing dialog box, the developer distinguished on the text OK, then any OK text in the page would become highlighted, to indicate that more than one area matches the constraints specified. This allows a developer to support multiple similar fields on a page simultaneously with one field item. Alternatively it indicates that the developer needs to be more specific in their distinguishing criteria.

As mentioned above, the identification routine running within the connector and the bubble application is hierarchical. That is, in order for a field match to occur, the screen identification must have already matched—this implies that the screen must be distinguished in order for the fields to have any chance of being recognized. This may be perceived as restrictive at first hand, implying that to support a field that appears on multiple screens the developer needs to photograph all occurrences on all screens. While this may be required, an alternative is simply ‘lightly’ distinguish one screen photograph that would match on all screens where the field occurs (e.g. Domain only). This would ensure that all the screens that match the domain constraint and match the field constraint can be supported by a single field item photograph.

As mentioned above, for distinguished photographs and/or fields within a photograph it is possible to associate an action script file, which determines the content to be delivered for a given context. In the example of FIG. 4, the Option_Action 56 is associated with the Yahoo Mail page. In the preferred embodiment, action script files are VBscript files. These files can be edited with a conventional text editor. When an action script file is in focus, the connector causes an Edit -> Action File option to be enabled, and selecting this option causes the connector to launch a program such as Microsoft Notepad. Alternatively, right clicking on an action script file and selecting Edit from a pop-up menu could also be used to launch Notepad.

Using an action script file provides an open extensible method enabling the provision of a range of support types and sources for distinguished contexts. For example, a particular action may be triggered when a match is found, such as activating a search for a particular keyword, as opposed to only being able to display a HTML page for particular topic as in the prior art.

The action script file name is based on the photograph XML file name, which should be unique within its directory. For example, the action file for a photograph could have the text ‘_action’ appended to its file name. This implies that if the developer drags and drops a distinguished photograph using the connection editor, the action script file is also included. If the drag and drop forces a photograph rename, this must also be applied to the photograph DOM action item that contains the reference to the action script file as well as the action script file itself.

As indicated above, the action file can be created initially by dragging an HTML page from browser or the address bar and dropping it in the “Linked to” section of the photograph/field action. This adds an action script file in this area, with the file initially having an entry to launch the page, but being editable later using a text editor. As also indicated, more than one action file can be associated with a photo/field—they will be executed in the order in which they appear.

Each action file contains XML & VBScript. The VBScript portions are executed by a launcher component 48 of the bubble application 26′ explained below. When editing these files with a text editor, in order to append/amend the activities triggered by the file, it is necessary to have a basic understanding of VBScript. It is nonetheless envisaged that a graphical editor could be developed to automatically manipulate these files without VBScript knowledge.

Once photographs have been distinguished and actions associated with the photos, the developer then needs to generate the index or lookup files 24 for an album. Within the connection editor, a menu option is available allowing a developer to do this. There may in fact be a series of such files associated with every album and possibly updates or additions to existing look-up files. The look-up files are placed in a location set by selecting an “Options -> Default Generate Location” menu option.

Every web application has its own look-up file(s) and these are based on the domain name in its photos. In this way, if a developer creates an album that contains a mixture of photographs from different source web applications, generating that album will affect more than one look-up file. It is therefore preferable to keep photographs of the same parent application in the same album. During the index file generation process, if no look-up file for a given application already exists, the generation process creates one. If the file already exists, it is updated. Following the generation process, a separate dialog pops up informing the developer of the file(s) that have been affected by the generation process. These files can then be uploaded or published to a web server either manually or automatically.

Turning now to the Bubble Application 26′. This to some extent corresponds with the bubble application 26 of the prior art and is used by an end-user to access support material for a web-based application. In the preferred embodiment, the bubble application comprises a system-tray-based component which when launched causes a small bubble icon (not shown) to reside in the system tray—the presence of this icon is configurable. To request support, the user clicks on the system tray bubble icon to activate support mode, at which time the mouse pointer changes to a bubble icon. The user then moves the bubble icon pointer over the area upon which support is required and then single clicks again to trigger the support request specific to this area (a pointed bottom tip of the bubble is the active area). Hovering the mouse over the bubble icon in the system tray results in a ToolTip as specified by a BubbleToolTip entry in a local or remote configuration file 43—preferably a text file stored at any resolvable URL (Uniform Resource Locator). Double-clicking on the bubble icon launches a configurable HTML page, which can be customized to give detailed instructions on how to use the bubble. If the bubble is clicked in error, pressing the Escape key unselects it and restores the mouse pointer, or a single click again on the bubble icon in the system tray/toolbar restores the mouse pointer.

The bubble application also includes a capture component 47 in the form of an ‘Ask Assistware’ toolbar 70, FIG. 6, which sits inside each instance of the browser on a client computer. The installation of the bubble inserts the Ask Assistware toolbar and right clicking on any toolbar and selecting the Ask Assistware toolbar option makes the toolbar visible within browser sessions. The toolbar 70 behaves in the same manner as other toolbars and can be disabled by right clicking on a blank area of the toolbar and selecting the Ask Assistware option. Repeating the exercise re-enables the toolbar and makes it visible. The toolbar 70 can also be dragged around, placing it in different locations, and it is also possible to resize the toolbar by dragging the size handle—the smallest size being the width of the text “Assistware”. By default, the toolbar contains an Ask button 72 and a drop down edit box 74. Many optional buttons can be implemented for the toolbar and they are included according to the setting of the configuration file 43. If such optional buttons are included in the configuration file, they are incorporated in the toolbar to the right of the Ask button 72, at the expense of the drop down list box 74 width. As in standard IE toolbar behavior, if insufficient space is available a >> indicator appears on the toolbar indicating more options are available, clicking on >> results in a drop down menu with the remaining options.

The user interface functionality provided by the toolbar 70 when visible enables requests for support to be triggered from within any browser sessions 40′, 40″ running on the client computer. Besides the visible functionality, however, the component 47 also includes a HTML capture component, corresponding to some extent with the functionality of the camera component 14′. The capture component, however, is used to snap shot only the HTML in the browser (the screen shot is not required) for use in distinguishing. In essence, the capture component captures all the underlying HTML in the users browser, places it on the clipboard 60 and causes the bubble application, acting as a listener for the clipboard event, to pass a request for support back to a distinguishing engine 38′. This capture and transfer of data is preferably read-only in that the HTML in the browser is not altered.

As mentioned above, the Connector generates output i.e. look up and action files 24 and these are preferably deployed on a web server. In the preferred embodiment, context sensitive requests for support are resolved (or distinguished) at the server side. In other words a server based distinguishing engine 38′ is required. Following a request for support received from a client bubble application, the engine 38′ takes the captured screen HTML delivered (via http) from the client and in conjunction with the appropriate lookup file, attempts to determine the action script file(s) to ‘use’. The result of the distinguishing comprises one or more URLs for appropriate action script files, which are then passed back to the client. Subsequent request(s) for the support material are then made by the launcher component 48 which makes HTTP requests for each of the returned URLs and parses the text of the returned script file(s).

An action script file can contain two forms of request:

Page support request: Here an HTML page contains the support material. This type of support material is displayed in a separate specific Assistware Support browser window session 40″. This is launched if it does not already exist or reused if it is already available. This avoids a situation where numerous drops of the bubble, one after another would result in multiple browser sessions appearing on the screen. In the action file it is possible to specify the name of the browser session to use.

Non-page support request: Here the request is for something other than an HTML page and could be say an executable file. In this case the command is simply passed to the operating system for processing.

In addition to this “application context” based support functionality, the bubble application 26′ also supports requests not relating to the web application. This is achieved by right clicking on the bubble icon and selecting for example a configurable Search option from a pop-up menu or one of the additional configurable buttons.

The bubble application installation file is preferably a digitally signed component, taking one parameter; the location of the configuration file 43. This allows a developer to place the bubble installation file on a website and have end users click on a hyperlink to install it. The hyperlink preferably includes the configuration file parameter. The configuration file 43 remotely controls the bubble application 26′ and toolbar 70, with their behavior settings being stored in user specific windows registry settings. Each time the bubble application is started the configuration file 43 is read and the registry settings updated. Alternatively, the bubble application can be configured to check the configuration file 43 for updates on a regular basis. In any case, storing behavior settings in the registry means that the bubble application can function on the last known settings even if the configuration file is not available. The configuration file can be used, for example, for a particular company that wishes to apply a of set standards across all users e.g. browser size and location. In the preferred embodiment, two types of configuration file exist—global and local. This is a cascading approach, where a global configuration file setting over rides the local setting, if it exists.

The toolbar 70 includes a button “Ask” 72. With the mouse over the button, a ToolTip says ‘Click to Ask Assistware a question’. A single click on the ‘Ask’ button passes the text in the Assistware drop-down list 74 back to a conventional search engine (not shown). If the drop-down list is empty, a pop-up message appears—‘No search text found. Please enter your search text in the Assistware drop down list box, then press the Ask button.’ Otherwise, the search engine produces and returns a search page to the end-user computer for rendering in a browser session.

It will be seen that the content in the browser session 40′ for which a user seeks support may be information of a personal or sensitive nature. If this data is transmitted to the client in a secure manner, it is preferable if the same secure channel is used to transmit the captured data to the distinguishing server 38′. However, this is dependent upon the web server and its configuration.

Another option is to encrypt the captured data itself before transmitting it. There are many products and standards already in the market place, with the trade off being between speed and security. The higher the security the more data generated e.g. application of a 128 bit key enlarges each data packet transmitted.

In order to avoid casual access to the captured data (which is placed on the clipboard 60), a registry setting “ClipBoardAccess” controls whether the captured data is placed on the accessible user clipboard or a hidden system clipboard. By default ClipBoardAccess is disabled, but can be enabled for troubleshooting and quality assurance purposes. It should be noted that this data does not affect what the user sees in their browser, and even tampering with the data has a low security impact; i.e. the wrong support will be displayed. Given that the bubble application does not control the application content displayed by the browser, neither can it alter the data displayed to the user, it is a read only application.

When an error occurs on an end-user computer, a message is passed back to a central sever indicating the date, time, error description, error code, user details (where possible) for the error. This facilitates remote trouble shooting of the client issue. This same mechanism is also used to monitor user activity in the system, with all bubble drops and user interactions being logged centrally in a simple comma delimited file that can be queried or reported on as required. The central tracking mechanism preferably uses a Java servlet at the server side, with the data transfer being disguised as a parameterized HTTP request intercepted by the servlet.

The embodiments above have been described in relation to Microsoft Internet Explorer. It will be seen that appropriate changes can be made to implement the invention with other browsers such as Netscape Navigator. Thus, rather than using an IE toolbar as the capture component 47, a Netscape specific sidebar plugin could be used.

A Netscape Sidebar can be deployed in two ways:

1. Over the Internet, but this does not install it on the client machine, so the URL must always be available to for the capture to work.

2. Installed on the client machine by running an install script. Here the sidebar is always available, regardless on the state of the Internet and this would be desirable if the client were using the browser to access local file based applications.

What is claimed is:

1. A content management system comprising:
a development tool operative to record a specific execution context of a user application displayed in a browser by making a record including at least part of a document object model constructed by the browser and to associate context-specific content with the record; and
a content display tool operative to compare the execution context of an executing user application that has a display on a browser with records made by the development tool and to display content associated record having a corresponding execution context.

2. A content management system according to claim 1 in which the development tool associates a representation of a display upon which the user application is visible at the execution context in the record.

3. A content management system according to claim 2 in which the representation includes an encoded image representing the application display.

4. A content management system according to claim 3 in which the image is encoded in a compressed format.

5. A content management system according to claim 1 in which the record includes the complete document object model in existence at the specific execution context.

6. A content management system according to claim 1 in which the record includes additional information relating to the execution context of the application.

7. A content management system according to claim 6 in which the additional information includes one or more selected from: the HTML title value of the page captured, the name of the domain from which the photograph was captured, the URL of the page captured, all the text in the captured page and all the HTML of the captured page.

8. A content management system according to claim 6 in which the additional information is information that is not present in the document object model.

9. A content management system according to claim 1 in which the record includes one or more distinguishing elements of the context.

10. A content management system according to claim 9 in which the distinguishing elements include one or more items in the document object model.

11. A content management system according to claim 1 in which the record includes a definition of an action to be associated with the context.

12. A content management system according to claim 11 in which the action defined by the record can be initiated by the content display tool.

13. A content management system according to claim 11 in which the action defined by the record is initiated in response to an input by a user.

14. A content management system according to claim 11 in which the action includes displaying a page in a browser.

15. A content management system according to claim 11 in which the action includes executing an application.

16. A content management system according to claim 1 in which the record includes XML code.

17. A content management system according to claim 1 in which the development tool is an application executing on a developer computer.

18. A content management system according to claim 1 in which the content display tool is an application executing on a user computer.

19. A content development system comprising a development application operative to record a specific execution context of a user application that has a display context displayed in a browser, the development application operating to make a record including at least part of the document object model of the browser, and to associating content with the execution context in the record.

20. A display system for displaying content with reference to the execution context of a user application that is executing with a display in a browser in which upon receipt of a request for content, the display system is operative to compare elements of a current document object model generated by the browser with records that define execution content with reference to the document object model, and upon location of a correspondence between the current document object model and a record to cause content to be displayed in accordance with a definition in the record.

21. A method of providing content specific to the execution context of a user application that has a display in a browser, the method comprising a content development phase in which the user application is executed and at each of a plurality of contexts with which content is to be associated, a record is made of a document object model of the browser and a reference to a content item is associated with the record; and a content display stage in which the user application and a content display tool are executed and the content display tool, the display tool, upon receiving a user request for content, compares a current document object model of the browser displaying the user application with the records made in the development phase, and displays content associated with a record that corresponds to the current document object model.

22. A method according to claim 21 in which correspondence between the recorded and current document object models is determined as having occurred when features of the current and recorded models match one another in accordance with one or more rules contained in the record.
